(19) United States
(12) Patent Application Publication
(10) Pub. No.: US 2024/0281568 A1
(43) Pub. Date: Aug. 22, 2024

(54) OVERALL HYDRAULIC PERFORMANCE PREDICTION METHOD FOR SINK-TYPE DISHWASHER

(71) Applicants: Jiangsu University, Zhenjiang City (CN); Wenling Fluid Machinery Technology Institute, Jiangsu University, Wenling City (CN)

(72) Inventors: Xikun WANG, Zhenjiang City (CN); Yalin LI, Zhenjiang City (CN); Haichao SUN, Zhenjiang City (CN); Yuhan GAO, Zhenjiang City (CN); Mingxuan LI, Zhenjiang City (CN); Yujian FANG, Wenling City (CN)

(73) Assignees: Jiangsu University, Zhenjiang City (CN); Wenling Fluid Machinery Technology Institute, Jiangsu University, Wenling City, Taizhou City (CN)

(21) Appl. No.: 18/418,341

(22) Filed: Jan. 22, 2024

(30) Foreign Application Priority Data
Feb. 16, 2023 (CN) 2023101248412

(51) Int. Cl. G06F 30/17; A47L 15/00; G01M 99/00

(52) U.S. Cl. CPC G06F 30/17; A47L 15/0086; G01M 99/005

(57) ABSTRACT

Method for predicting the overall hydraulic performance of a sink-type dishwasher. Process begins with unsteady numerical computation on a dishwasher pump under static conditions to obtain a characteristic pump curve. Using this curve, rotation velocity adaptation coefficient (A_{d}) and axial velocity coefficient (B_{d}) are determined. Mapping relationship is established between composite superposition virtual impeller and composite impeller. Passive rotation velocity of the volute and the nozzle flow rate are calculated using GMO model and virtual impeller. A jet mass source is established, using the nozzle flow rate and the volute's passive rotation velocity as boundary conditions. This leads to a non-submerged rotating jet flow computation with a multi-nozzle setup using the VOF method. This approach streamlines the dishwasher's intricate multi-physics, conserves computing resources, and effectively resolves issues related to free surface divergence and estimating the volute's passive rotation speed, leading to an accurate prediction of the dishwasher's overall hydraulic performance.

### TECHNICAL FIELD

The present invention relates to a simulation prediction method for an internal hydraulic washing mechanism of a dishwasher, and in particular to an overall hydraulic performance prediction method for a sink-type dishwasher based on a multi-physics coupling simulation strategy, so as to solve the problems: the difficulty in accurately describing the turbulence model that occurs when directly simulating the internal turbulence mechanism of a dishwasher; the difficulty in achieving convergence of the residual curve; the difficulty in effectively controlling a computation process due to a variable negative angle of the dynamic mesh caused by the passive rotation velocity of the volute and lack of conservation of mass caused by a free surface; and the excessive demand for computing resources.

### BACKGROUND ART

As a household kitchen appliance, dishwashers have successfully liberated people's hands from repeated dish washing work.

In recent years, Fotile has developed a sink-type dishwasher. The dishwasher is provided with a new type of dishwasher water pump, namely, a twin-volute type spraying arm. A volute in a working state will be passively rotated, thereby inducing a rotating jet flow. The passive rotation involves the problems of gas-liquid two-phase flow, free surface flow, six-degree-of-freedom motion, and fluid-structure interaction. The rotating jet flow is subject to the category of non-submerged jet flow, and also involves the problems of free surface flow and gas-liquid two-phase flow. It can be seen that the passive rotation of the volute is an extremely complex multi-physics problem. If the existing simulation technology is used for an overall simulation, there are still some significant difficulties in accurately simulating its internal flow characteristics. This is mainly manifested in the challenges of selecting an appropriate turbulence model, the substantial consumption of simulation computing resources, and problems such as the passive rotation velocity of the volute causing the dynamic mesh to easily vary in negative angle and the free surface causing a lack of mass conservation, making it difficult to achieve convergence and control in the computation process. Therefore, the creation of an overall simulation prediction method has become an important issue to be addressed for sink-type dishwashers.

Through the search, there is no relevant report on an overall simulation prediction method for sink-type dishwasher based on multi-physics coupling strategy.

### SUMMARY

In view of the problems existing in the existing simulation technology, an object of the present invention is to overcome the problem of multi-physics complex simulation caused by passive rotation of a volute in a dishwasher, and to provide a step-by-step overall simulation prediction method for a dishwasher. Via the present invention, the problems of direct simulation, such as the difficulty in accurately describing the flow field by complex turbulence model, and the extreme difficulty in convergence of computation, can be solved, thus saving computing resources. Simulation results are closer to the real situation.

In order to solve the above technical problems, the specific technical solution adopted by the present invention is as follows:

An overall hydraulic performance prediction method for the new sink-type dishwasher includes the following steps:
step 1: conducting numerical simulations on a composite impeller and a twin-volute spraying arm within the dishwasher, and acquiring the pump characteristic curve of the new type of dishwasher pump when the spraying arm is static;
step 2: obtaining the full-open flow rate Q₀ from the pump characteristic curve, obtaining the rotation velocity adaptation coefficient A_{d} and the axial velocity coefficient B_{d}, performing unsteady simulation on the passive rotation of the volute using the GMO-TruVOF method, then the passive rotation velocity of the volute and the flow rate at the exit of each nozzle can be obtained; and
step 3: taking the passive rotation velocity of the volute and the flow rate at the exit of each nozzle as initial conditions, conducting non-submerged rotational unsteady computation on the nozzles based on the FAVOR-TruVOF method, obtaining flow parameters such as hydraulic washing pressure of the dishwasher, and estimating the hydraulic washing capacity of the dishwasher.

Step 1 specifically includes the following processes:
process 1.1: constructing the water body of the new type of dishwasher pump based on models of the composite impeller and the volute type spraying arm, meshing by using ICEM software, and performing unsteady simulation of the new type of dishwasher pump with Fluent software; and
process 1.2: conducting numerical simulation predictions of the pump characteristic curve by using the RANS method, calculating the head at a minimum of five different flow rates under static conditions of the volute, and plotting the pump characteristic curve.

Step 2 specifically includes the following processes:
process 2.1: determining the full-open flow rate Q₀ using the pump characteristic curve obtained in process 1.2; acquiring the rotation velocity adaptation coefficient A_{d}, and the axial velocity coefficient B_{d} suitable for the new type of dishwasher pump; constructing a new composite virtual impeller model within the FLOW-3D software, and establishing a mapping relationship between parameters of the virtual impeller and the composite impeller;
process 2.2: constructing the near-field computational domains at the exits of the nozzles, conducting Cartesian meshing on the virtual impeller, the volute spraying arm, and the near field of the nozzle jet flow domain based on FAVOR technology, and selecting an appropriate mesh resolution to ensure effective analysis of the computational domain; and
process 2.3: enabling fluid-structure interaction and free surface computation of the new type of dishwasher pump based on the virtual impeller and the GMO-TruVOF method to realize the numerical simulation of the passive rotation of the volute, and monitoring the passive rotation velocity of the volute and the flow rate at the exit of each nozzle.

Step 3 specifically includes the following processes:
process 3.1: constructing a gas-liquid two-phase non-submerged jet flow computational domain with a free surface in a sink of the dishwasher, and setting a jet mass source in the computational domain;
process 3.2: computing a complex non-submerged rotating jet flow field of a multi-nozzle combination based on the FAVOR-TruVOF method by taking the flow rate at the exit of each nozzle and the passive rotation velocity of the volute obtained in process 2.3 as boundary conditions of the jet mass source; and
process 3.3: post-processing non-submerged rotating jet flow computation results, which includes analyzing distribution laws of jet flow impact pressure, vorticity, and other flow parameters, as well as evaluating the overall hydraulic performance of the dishwasher.

In process 1.3, the RANS method is used to simulate pump characteristics of the new type of dishwasher pump. In order to reduce simulation errors, it omits simulating the small flow rate condition and instead, ensures obtaining at least five sets of data relating to head and flow rate. These datasets are then subjected to linear approximation fitting, which includes fitting the pump characteristic curve to obtain the full-open flow rate Q₀. Additionally, it also involves solving for rotation velocity adaptation coefficient A_{d} and axial velocity coefficient B_{d} using Q₀ and a parameter relationship between the original impeller and the virtual impeller. The fitted linear expression is as follows:

$$h = a Q + {Q}_{0}$$

where
h represents the head of a pump, m;
a represents the slope of the straight line;
Q represents the flow rate, l/min;
Q₀ represents both the horizontal axis intercept of a fitted straight line and the full-open flow rate of the pump.

The original impeller and the virtual impeller have the following geometric relationship:

$$\begin{matrix}{H}_{y 1} = L cos {β}_{L} \\ {H}_{y 2} = H + {b}_{2} - 0.3 D \\ {D}_{y 1} = D \\ {D}_{y 2} = {D}_{2} \\ {D}_{y 3} = {d}_{h}\end{matrix}$$

where the left side of the equation shows geometric parameters of the two virtual impellers, and the right side of the equation shows several geometric parameters of the original impeller.
H_{y1} is the height of the virtual impeller I, m;
D_{y1} is the outer diameter of the virtual impeller I, m;
H_{y1} is the height of a virtual impeller II, m;
D_{y2} is the outer diameter of the virtual impeller II, m;
D_{y2} is the hub diameter of the virtual impeller, m;
L is the airfoil chord length of the original impeller, m;
β_{L} is the airfoil angle of the original impeller, °;
H is the height of the back cover plate of the original impeller, m;
b₂ is the outlet width of the original impeller, m;
D is the minimum outer diameter of the original impeller, m;
D₂ is the maximum outer diameter of the original impeller, m;
dₕ is the hub diameter of the original impeller, m.

The rotation velocity adaptation coefficient A_{d} and the axial velocity coefficient B_{d} for the new type of dishwasher pump obtained according to the full-open flow rate Q₀ and the parameter relationship between the virtual impeller and the composite impeller are as follows:

$${A}_{d} = \frac{π {gn}^{2} {D}_{2}^{2} ( {C}_{1} {D}^{2} + {C}_{2} {D}_{2}^{2} )}{4 {Q}_{0} ( L cos {β}_{L} + H + {b}_{2} - 0.3 D )}$$

$${B}_{d} = \frac{12 {Q}_{0}}{π n ( {D}_{2}^{3} - {D}^{3} )}$$

where C₁=φπ²/3600 g (φ=0.92−0.98), and C₂=ψπ²/3600 g (ψ=0.67−0.75).

In process 2.1, the construction a composite superposition virtual impeller model includes: innovating the rotation velocity adaptation coefficient A_{d} and the axial velocity coefficient B_{d} for the new type of dishwasher pump. Additionally, in combination with the parameter mapping relationship between the composite impeller and the virtual impeller, a virtual impeller assembly is constructed. This assembly comprises two cylinders stacked up and down, replacing a forward curved axial flow cascade and a centrifugal radial blade of the impeller. The outer diameters and heights of the cylinders define the region swept by the blade, and the size of the inner diameter is set. A region fluid flowing out of the cylinders at a certain vortex and axial velocity is also defined, and rotation axes of the cylinders are determined using the two-point method.

In process 2.2, the construction the near field of a non-submerged jet flow domain involves selecting a non-submerged nozzle jet flow height. This height ensures that the water flows out from the nozzles without impacting the monitoring of the nozzle flow rate. It is crucial that the height has no or negligible effect on the setting of the jet mass source in step 3. A recommended near-field height of the jet flow domain is set at 1-2 times the nozzle diameter of the highest point at the top of the nozzle opening.

Process 3.1 involves setting a mass source, encompassing defining an inflow source in the computational domain, which includes setting the position, direction, geometry, and flow velocity of the mass source. The distance between the mass source and the exit of the nozzle is set at 1.5 times the nozzle diameter. Notably, the flow rate is set as a function of time, and is aligned with the flow rate of each nozzle obtained in process 2.3.

The advantageous effects of the present invention are notable. By implementing a step-by-step multi-physics coupling simulation strategy in the overall simulation of a dishwasher, significant conservation of simulation resources is achieved. Additionally, the simulation results more closely align with the real operational conditions of the dishwasher. Furthermore, the challenges that arise from direct simulation of a variable negative angle of a dynamic mesh due to passive rotation velocity of a volute and the lack of mass conservation resulting from a free surface can be effectively circumvented. Moreover, the present invention's numerical simulation of the external characteristics of the new type of dishwasher pump model under different flow conditions in static conditions bypasses the need for non-submerged jet flow simulation with a free surface involving a volute type spraying arm nozzle. The construction of a virtual impeller enables a comprehensive and three-dimensional simulation of the flow characteristics of the impeller based on a simplified impeller model, leading to a reduction in the number of Cartesian orthogonal grids. The six-degree-of-freedom physical field of a non-submerged jet flow of a volute type spraying arm can be simulated by simply setting a jet flow mass source. In addition, the new type of dishwasher pump model is thoroughly studied, employing a novel step-by-step coupling simulation strategy, and by setting the jet flow mass source, a complex model can be simplified and complex superposition physics can be subdivided. Moreover, simulation data and results from the preceding step can be seamlessly transmitted to the next step. This approach significantly reduces the computational burden and improves convergence compared to direct simulation, consequently enhancing the accuracy and fidelity of hydraulic performance prediction for the dishwasher

### BRIEF DESCRIPTION OF THE DRAWINGS

FIG. 1 is the flowchart of simulation prediction of a dishwasher.

FIG. 2 is the new type of dishwasher pump model of a dishwasher and a water body computational domain.

FIG. 3 is the pump characteristic curve prediction (solid line) of the new type of dishwasher pump and a fitting approximate value (dashed line).

FIG. 4 is the geometric model of the virtual impeller.

FIG. 5 is the structural diagram of the radial-type blade of the composite impeller.

FIG. 6 is the plan view of the forward curved axial flow cascade of the composite impeller.

FIG. 7 is the Cartesian coordinate division diagram of the new type of dishwasher pump.

FIG. 8 shows the variation of the volute passive rotation velocity.

FIG. 9 shows the fluid velocity of the monitoring point at the exit of each nozzle.

FIG. 10 shows the arrangement of the mass source on volute.

FIG. 11 shows the variation of mean pressure on the top surface of the tank over time.

### DETAILED DESCRIPTION OF THE EMBODIMENTS

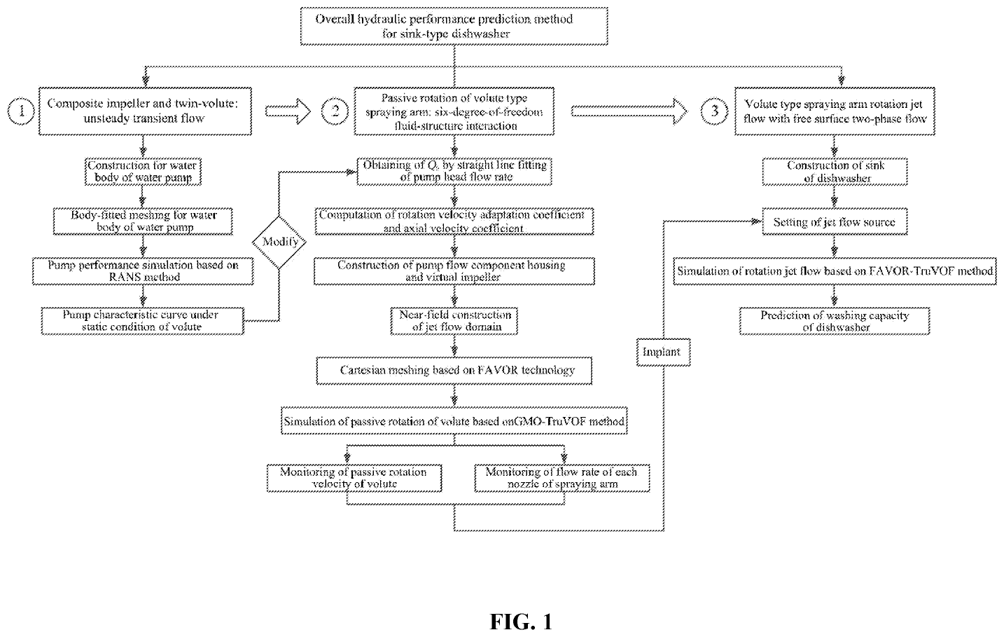

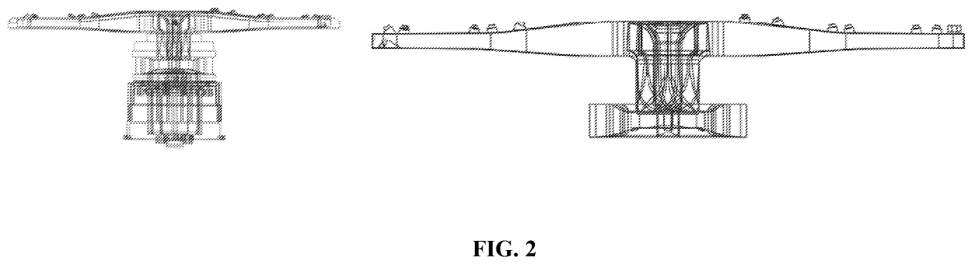

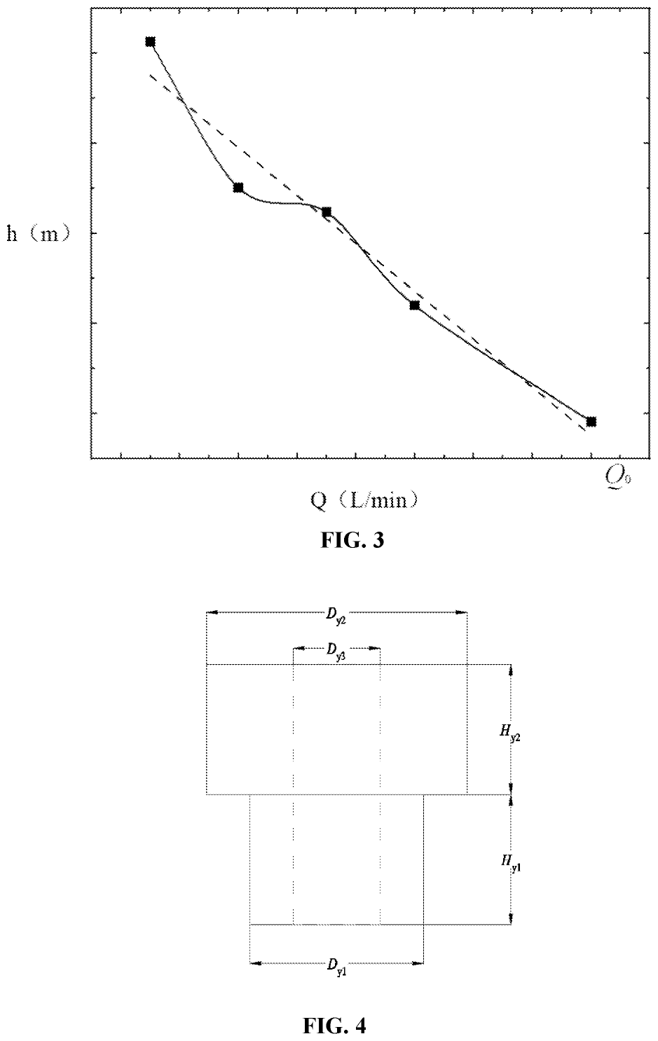

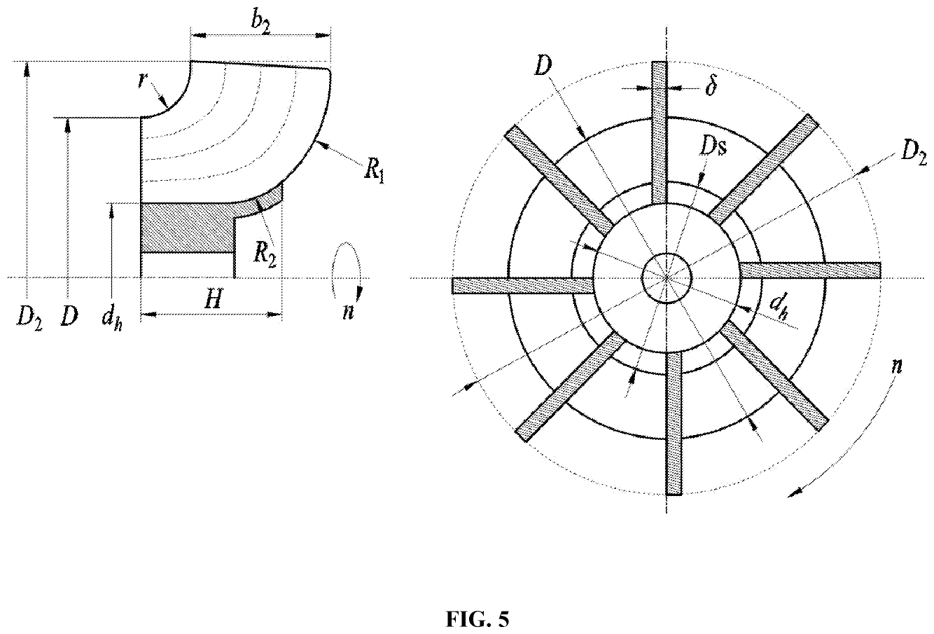

Hereinafter, the technical solutions of the present invention will be described in detail with reference to the accompanying drawings and specific embodiments.
(1) The hydraulic performance prediction of a dishwasher under a multi-physics coupling simulation strategy is achieved using a geometric model of a new type of dishwasher pump of the dishwasher. The whole prediction flow is illustrated in FIG. 1.
(2) The multi-physics problems of the dishwasher are primarily concentrated on a volute type spraying arm. To accurately obtain the heads of the dishwasher pump under different flow rates without computational divergence, a static state simulation of the volute is conducted. A structural diagram of the pump model and its computational domain are depicted in FIG. 2.
(3) The meshing process is conducted using ICEM software, employing hexahedral structure meshes. The computational domain is segmented into four computational regions: an inlet flow channel, a diversion loop flow channel, an impeller flow channel, and a volute flow channel. Additionally, a boundary layer is incorporated into the wall surface for localized refinement.
(4) Fluent software is employed for performing the external characteristic simulation computation. The k−ω turbulence model is adopted for steady computation. The inlet uses the flow inlet boundary condition with a specified flow rate setting. The outlet adopts the pressure outlet boundary condition with ambient atmospheric pressure. The wall surface is subject to a non-slip boundary condition. The impeller domain and the diversion loop water domain have a rotation velocity of n, while other components are set as static domains. The computation is performed using the SIMPLE algorithm, and a second-order upwind difference scheme is employed in the discrete process.
(5) The performance curve based on RANS numerical simulation prediction is depicted as the solid line in FIG. 3. As simulation errors are considerable under extreme conditions, linear fitting is conducted based on a minimum 0.5 Q_{d} condition, resulting in the fitting result shown as the dotted line in FIG. 4. Through the linear fitting curve, an approximate equation of the pump characteristic curve may be derived:

$$h = a Q + {Q}_{0} \qquad ( Equation 1 )$$

where a is the slope of the fitted straight line, and Q₀ represents the horizontal axis intercept of the fitted straight line and serves as the full-open flow rate of the pump.

A maximum head and the full-open flow rate may be respectively expressed as:

$$Δ h = \frac{{L}_{0}}{g} \cdot \frac{{Q}_{0}}{π {R}^{* 2}} \cdot {A}_{d} \qquad ( Equation 2 )$$

$${Q}_{0} = \frac{2}{3} π ( {R}^{* 3} - {r}^{3} ) n {B}_{d} \qquad ( Equation 3 )$$

where Δh represents the maximum head, L₀ is the total height of the impeller, g is gravitational acceleration, Q₀ is the full-open flow rate, R* is the outer radius of the impeller, r represents the minimum radius of the impeller, and n represents the rotation velocity of the impeller.
(6) The virtual impeller geometry is shown in FIG. 4. Two hollow cylinders have the same inner diameter. D_{y3} is the hub diameter, D_{y2} is the impeller diameter, D_{y1} is the minimum impeller diameter, H_{y1} is the height of impeller I, H_{y2} is the height of impeller II, and the heights of the impellers have the following relationship:

$${H}_{y 1} + {H}_{y 2} = {L}_{0} \qquad ( Equation 4 )$$

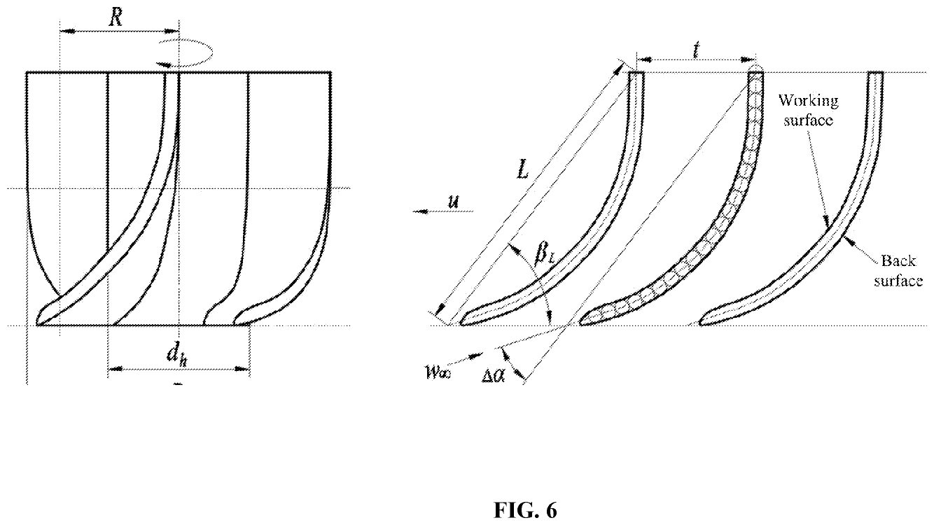

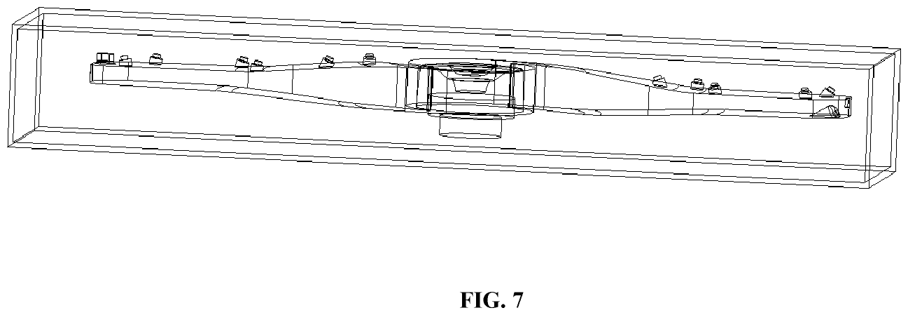

(7) The structural diagram of a centrifugal radial impeller of a composite impeller is depicted in FIG. 5, with the primary parameters encompassing D as the inlet diameter of the impeller, D₂ as the outlet diameter of the impeller, b₂ as the outlet width of the impeller, dₕ as the hub diameter of the impeller, H as the height of a back cover plate of the impeller, and δ as the blade thickness.
(8) FIG. 6 shows the plan view of a forward curved axial flow cascade of a composite impeller, where the main geometric parameters include L as the airfoil chord length, dₕ as the hub diameter of the impeller, β_{L} as the airfoil angle, z as the number of blades, t as a grid distance (calculated as t=2πR/z), R as the radius of a cylindrical laminar flow surface, and Δα as the attack angle, namely, the angle between an incoming flow direction and a chord.
(9) The radial blade illustrated in FIG. 5 and the forward curved axial flow cascade depicted in FIG. 6 together constitute the original composite impeller. The mapping relationship between the partial parameters of the composite impeller and the parameters of the virtual impeller is established:

$${H}_{y 1} = L cos {β}_{L} \qquad ( Equation 5 )$$

$${H}_{y 2} = H + {b}_{2} - 0 \text{.3} D \qquad ( Equation 6 )$$

$${D}_{y 1} = D \qquad ( Equation 7 )$$

$${D}_{y 2} = {D}_{2} \qquad ( Equation 8 )$$

$${D}_{y 3} = {d}_{h} \qquad ( Equation 9 )$$

(10) By employing the mapping relationship between the geometric parameters of the composite impeller model and the virtual impeller, and in conjunction with the full-open flow rate Q₀ obtained by fitting the head flow curve of the new type of dishwasher pump, a simultaneous relationship of the rotation velocity adaptation coefficient A_{d} and the axial velocity coefficient B_{d} with the full-open flow rate Q₀ and the parameters of the composite impeller can be derived from (Equation 2) to (Equation 9):

$${A}_{d} = \frac{π g {n}^{2} {D}_{2}^{2} ( {C}_{1} {D}^{2} + {C}_{2} {D}_{2}^{2} )}{4 {Q}_{0} ( L cos {β}_{L} + H + {b}_{2} - 0.3 D )} \qquad ( Equation 10 )$$

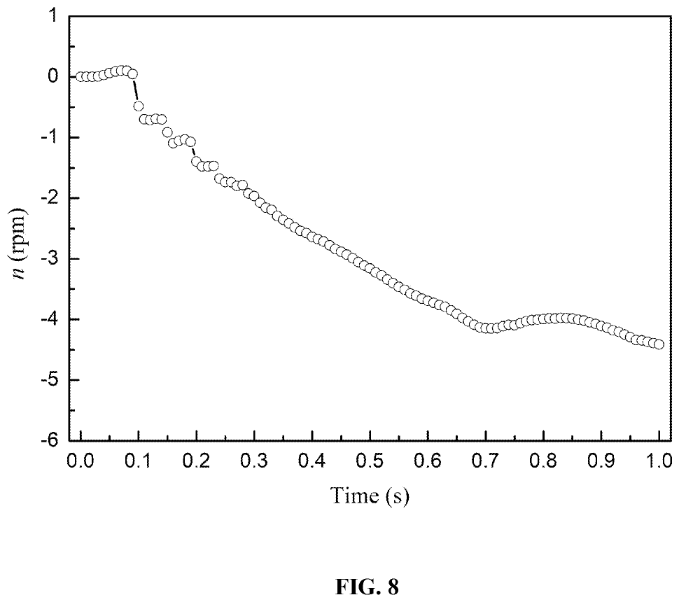

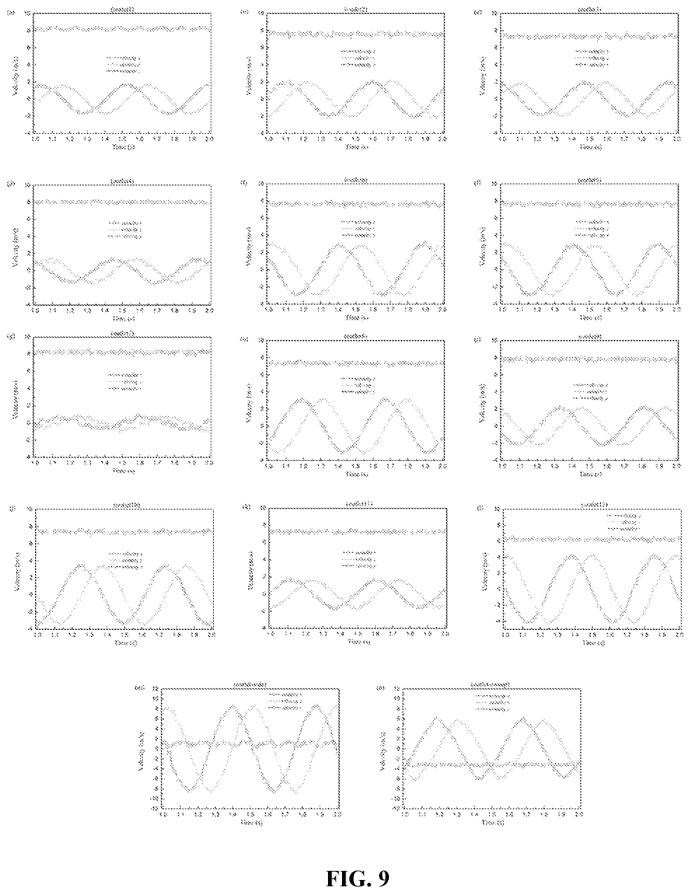

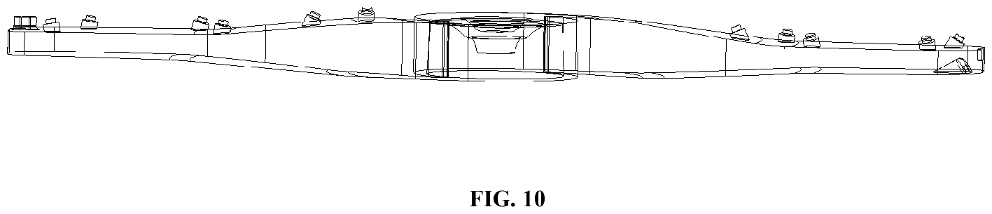

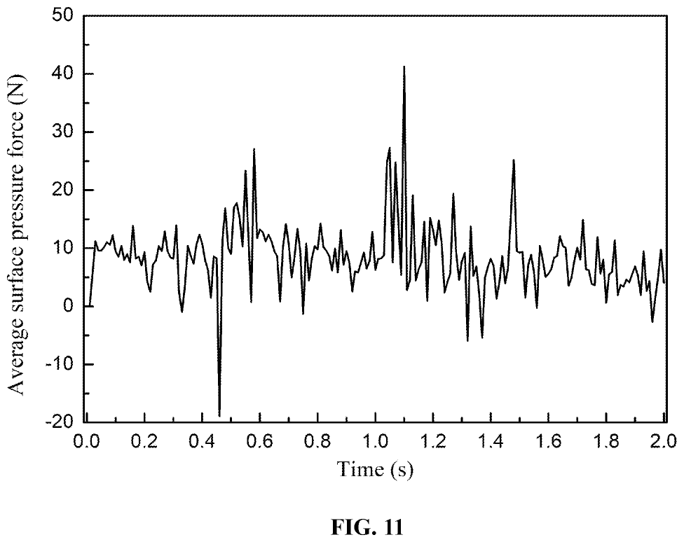

The axial velocity coefficient is:

$${B}_{d} = \frac{12 {Q}_{0}}{π n ( {D}_{2}^{3} - {D}^{3} )} \qquad ( Equation 11 )$$

where C₁=φπ²/3600 g (φ=0.92−0.98), and C₂=ψπ²/3600 g (ψ=0.67−0.75).
(11) Based on the parameter mapping relationship between the original impeller and the virtual impeller as stated in (Equation 5) to (Equation 9), specific values of the parameters of the composite impeller of the new type of dishwasher pump, the rotation velocity adaptation coefficient A_{d}, and the axial velocity coefficient B_{d} are imported into a setting interface of the virtual impeller in FLOW-3D, where a virtual impeller model and the spraying arm are subsequently constructed.
(12) Adhering to the meshing principle of the FAVOR technology, Cartesian meshing is executed on the overall model using FLOW-3D. As exemplified in FIG. 7, the distance between the top surface of the jet flow near-field computational domain and the nozzle is approximately 1-2 times the nozzle diameters. To circumvent the tracking of jet flow fields of the whole nozzles, the required outlet flow velocity of each nozzle and the passive rotation velocity of the volute are simultaneously monitored. A mesh resolution is set to be no more than 1/20 of the minimum nozzle diameter. Specific computation and time steps are determined, and the requisite hydraulic computation data is verified.
(13) A GMO coupling motion option in a Moving and Simple Deforming Objects model of a physics interface in FLOW-3D is enabled, and a baffle is inserted near the exit of the nozzle, specifically establishing a flow velocity monitoring surface at each outlet of the volute. The passive rotation of the volute is simulated using a TruVOF method, and the variation of the rotation velocity of the volute and the flow velocity at each nozzle exit over time are closely monitored, as depicted in FIG. 8 and FIG. 9.
(14) The construction of the dishwasher sink is accomplished using Creo software, with particular attention paid to creating the top surface of the sink body and embedding a volute model into the sink model.
(15) The work completed in (12) are replicated in the FLOW-3D simulation software. An overall jet inflow source is configured, ensuring that the shape of the mass source aligns with the nozzle exit. To address the complex issue of determining the direction of the mass source, the mass source is horizontally embedded above each nozzle, with the distance between the mass source and the exit of the nozzle set at 1.5 times the nozzle diameter, as illustrated in FIG. 10. Additionally, the outlet flow velocity of each nozzle obtained through monitoring in step (13) is inputted accordingly.
(16) The data obtained by monitoring in step (13) is integrated into the mass source, facilitating the simulation of nozzle jet flow under the passive rotation of the volute using the TruVOF method.
(17) Subsequently, the simulation results of the non-submerged rotating jet flow are subjected to post-processing, encompassing the evaluation of the variation pattern of the average water pressure on the top surface of the sink body over time. The computation of the water pressure adheres to the formulas detailed in Equation (12) and Equation (13).

$$\overline{P} = \int {\overline{P}}_{t} dt / Δ t \qquad ( Equation 12 )$$

$${\overline{P}}_{t} = \int PdA / \int d A \qquad ( Equation 13 )$$

where A is the area of a stress surface, m²; t is time, s; P̅ is an average pressure per unit of time, N; P̅₁ is the average pressure of the plate at different moments, N.
(18) The ultimate prediction outcome regarding the washing capacity of the dishwasher is depicted in FIG. 11. Moreover, the estimation of the maximum impact force and the average impact force is conducted by observing the fluctuation pattern of stress on a top plate over time.

What is claimed is:

1. An overall hydraulic performance prediction method for the sink-type dishwasher, comprising the following steps:
step 1: conducting numerical simulations on a composite impeller and a twin-volute spraying arm within a dishwasher to obtain the pump characteristic curve for the new type of dishwasher pump under the static condition of the volute;
step 2: obtaining the full-open flow rate Q₀ from the pump characteristic curve, obtaining the rotation velocity adaptation coefficient A_{d} and the axial velocity coefficient B_{d}, performing unsteady simulation on the passive rotation of the volute using the GMO-TruVOF method, and obtaining the passive rotation velocity of the volute and the flow rate at the exit of each nozzle; and
step 3: taking the passive rotation velocity of the volute and the flow rate at the exit of each nozzle as initial conditions, conducting non-submerged rotational unsteady computation on the nozzles based on the FAVOR-TruVOF method, obtaining flow parameters such as hydraulic washing pressure of the dishwasher, and estimating the hydraulic washing capacity of the dishwasher.

2. The overall hydraulic performance prediction method for a sink-type dishwasher according to claim 1, wherein the conducting numerical simulations on a composite impeller and a twin-volute spraying arm within a dishwasher to obtain the pump characteristic curve for the new type of dishwasher pump under the static condition of the volute comprises the following processes:
process 1.1: constructing the water body of the new type of dishwasher pump based on models of the composite impeller and the volute type spraying arm, meshing by using ICEM software, and performing unsteady simulation of the new type of dishwasher pump with Fluent software; and
process 1.2: conducting numerical simulation predictions of the pump characteristic curve by using the RANS method, computing the head at a minimum of five different flow rates under the static condition of the volute, and plotting the pump characteristic curve.

3. The overall hydraulic performance prediction method for the sink-type dishwasher according to claim 2, wherein the obtaining the full-open flow rate Q₀ from the pump characteristic curve, obtaining the rotation velocity adaptation coefficient A_{d} and the axial velocity coefficient B_{d}, performing unsteady simulation on the passive rotation of the volute using the GMO-TruVOF method, and obtaining the passive rotation velocity of the volute and the flow rate at the exit of each nozzle comprises the following processes:
process 2.1: determining the full-open flow rate Q₀ using the pump characteristic curve obtained in process 1.2, acquiring the rotation velocity adaptation coefficient A_{d}, and the axial velocity coefficient B_{d} suitable for the new type of dishwasher pump, constructing a new composite virtual impeller model within the FLOW-3D software, and establishing a mapping relationship between parameters of the virtual impeller and the composite impeller;
process 2.2: constructing the near-field computational domains at the exits of the nozzles, conducting Cartesian meshing on the virtual impeller, the volute spraying arm, and a near field of a nozzle jet flow domain based on FAVOR technology, and selecting an appropriate mesh resolution to ensure effective analysis of the computational domain; and
process 2.3: enabling fluid-structure interaction and free surface computation of the new type of dishwasher pump based on the virtual impeller and the GMO-TruVOF method to realize the numerical simulation of the passive rotation of the volute, and monitoring the passive rotation velocity of the volute and the flow rate at the exit of each nozzle.

4. The overall hydraulic performance prediction method for the sink-type dishwasher according to claim 3, wherein the taking the passive rotation velocity of the volute and the flow rate at the exit of each nozzle as initial conditions, conducting non-submerged rotational unsteady computation on the nozzles based on the FAVOR-TruVOF method, obtaining flow parameters such as a hydraulic washing pressure of the dishwasher, and estimating the hydraulic washing capacity of the dishwasher comprises the following processes:
process 3.1: constructing a gas-liquid two-phase non-submerged jet flow computational domain with a free surface in a sink of the dishwasher, and setting a jet mass source in the computational domain;
process 3.2: computing the complex non-submerged rotating jet flow field of a multi-nozzle combination based on the FAVOR-TruVOF method by taking the flow rate at the exit of each nozzle and the passive rotation velocity of the volute obtained in process 2.3 as boundary conditions of the jet mass source; and
process 3.3: post-processing non-submerged rotating jet flow computation results, which comprises analyzing distribution laws of jet flow impact pressure, vorticity, and other flow parameters, as well as evaluating the overall hydraulic performance of the dishwasher.

5. The hydraulic performance prediction method for the sink-type dishwasher based on the multi-physics coupling simulation strategy according to claim 1, wherein in process 1.2, the heads under the five flow rates exclude conditions of flows less than 0.2Q_{d}, while the resultant five groups of data undergo linear approximation fitting.

6. The hydraulic performance prediction method for a sink-type dishwasher based on the multi-physics coupling simulation strategy according to claim 5, wherein the linear approximation fitting comprises fitting the pump characteristic curve to obtain the full-open flow rate Q₀, and determining the rotation velocity adaptation coefficient A_{d} and the axial velocity coefficient B_{d} suitable for the new type of dishwasher pump by using Q₀ and a parameter relationship between an original impeller and the virtual impeller, the fitted linear expression being as follows:
$$h = a Q + {Q}_{0}$$
wherein
h represents the head of the pump, m;
a represents the slope of a straight line;
Q represents the flow rate, l/min;
Q₀ represents both the horizontal axis intercept of the fitted straight line and the full-open flow rate of the pump;
the mapping relationship between the parameters of the composite impeller and the virtual impeller is as follows:
$$\begin{matrix}{H}_{y 1} = L cos {β}_{L} \\ {H}_{y 2} = H + {b}_{2} - 0.3 D \\ {D}_{y 1} = D \\ {D}_{y 2} = {D}_{2} \\ {D}_{y 3} = {d}_{h}\end{matrix}$$
wherein the left side of the equation shows the geometric parameters of the composite superposition virtual impeller, and the right side of the equation shows the geometric parameters of the composite impeller;
H_{y1} is the height of the virtual impeller I, m;
D_{y1} is the outer diameter of the virtual impeller I, m;
H_{y1} is the height of the virtual impeller II, m;
D_{y2} is the outer diameter of the virtual impeller II, m;
D_{y2} is the hub diameter of the virtual impeller, m;
L is the airfoil chord length of the original impeller, m;
β_{L} is the airfoil angle of the original impeller, °;
H is the height of the back cover plate of the original impeller, m;
b₂ is the outlet width of the original impeller, m;
D is the minimum outer diameter of the original impeller, m;
D₂ the maximum outer diameter of the original impeller, m;
dₕ is the hub diameter of the original impeller, m;
the rotation velocity adaptation coefficient A_{d} and the axial velocity coefficient B_{d} for the new type of dishwasher pump obtained according to the full-open flow rate Q₀ and the parameter relationship between the virtual impeller and the composite impeller being as follows:
$${A}_{d} = \frac{π {gn}^{2} {D}_{2}^{2} ( {C}_{1} {D}^{2} + {C}_{2} {D}_{2}^{2} )}{4 {Q}_{0} ( L cos {β}_{L} + H + {b}_{2} - 0.3 D )}$$
$${B}_{d} = \frac{12 {Q}_{0}}{π n ( {D}_{2}^{3} - {D}^{3} )}$$
wherein C₁=φπ²/3600 g (0.0.92−0.98), and C₂=ψπ²/3600 g (ψ=0.67−0.75).

7. The overall hydraulic performance prediction method for the sink-type dishwasher according to claim 3, wherein in process 2.1, the constructing a new composite virtual impeller model comprises: innovating the rotation velocity adaptation coefficient A_{d} and the axial velocity coefficient B_{d} for the new type of dishwasher pump, and constructing, in combination with the parameter mapping relationship between the composite impeller and the virtual impeller, a virtual impeller assembly, namely, two cylinders stacked up and down, to respectively replace a forward curved axial flow cascade and a centrifugal radial blade of the impeller, outer diameters and heights of the cylinders describing a region swept by the blade, the size of the inner diameter being set, a region fluid flowing out of the cylinders at a certain vortex and axial velocity being defined, and the rotation axes of the cylinders being determined using the two-point method.

8. The overall hydraulic performance prediction method for the sink-type dishwasher according to claim 3, wherein in process 2.2, the near-field computational domains at the outlets of the nozzles are obtained by selecting a non-submerged nozzle jet flow height, the jet flow height is required to ensure that the water flows out from the nozzles without impacting the monitoring of the nozzle flow rate, and is also required to have no effect or negligible effect on the setting of the jet mass source in step 3, and the near-field height of a jet flow domain is recommended to be 1-2 times the nozzle diameter of the highest point at the top of a nozzle opening.

9. The overall hydraulic performance prediction method for the sink-type dishwasher according to claim 1, wherein in process 3.1, the setting of a jet mass source in the computational domain comprises defining an inflow source in the computational domain, comprising the setting of the position, direction, geometry, and flow velocity of the inflow source, and the distance between the mass source and the exit of the nozzle is about 1.5 times the nozzle diameter; in particular, the flow rate is set as a function of time, and the data aligns with the flow rate of each nozzle obtained in process 2.3.
